(19) United States
(12) Patent Application Publication
(10) Pub. No.: US 2021/0281977 A1
(43) Pub. Date: Sep. 9, 2021

(54) INDOOR POSITIONING SYSTEM FOR A MOBILE ELECTRONIC DEVICE

(71) Applicant: Xerox Corporation, Norwalk, CT (US)

(72) Inventors: Fritz Francis Ebner, Pittsford, NY (US); Abhisek Dey, Rochester, NY (US); Karthik Subramanian, Rochester, NY (US); Matthew David Levesque, Henrietta, NY (US); Aaron Zachary Borden, Pittsford, NY (US); Matthew Dylan Coene, Ontario, NY (US)

(21) Appl. No.: 17/326,477

(22) Filed: May 21, 2021

Related U.S. Application Data
(63) Continuation-in-part of application No. 17/088,786, filed on Nov. 4, 2020.
Application No. 17/088,786 is a continuation-in-part of application No. 16/809,898, filed on Mar. 5, 2020, now Pat. No. 11,026,048.

(51) Int. Cl. H04W 4/029; G01C 21/20; G06N 3/08; G06N 3/04

(52) U.S. Cl. CPC H04W 4/029; G06N 3/04; G06N 3/08; G01C 21/206

(57) ABSTRACT

Systems and methods for navigating an environment are provided. A method includes determining a starting location and a destination location in an environment, receiving a graph representation of a map of the environment, determining a plurality of candidate paths from the starting location to the destination location, identifying which of the plurality of candidate paths is a shortest path from the starting point location to the destination object location, selecting the shortest path as a path to navigate from the starting location to the destination location, generating a token comprising one or more instructions for navigating the shortest path, and causing the token to be displayed on a display device of an interactive kiosk, wherein the one or more instructions comprise one or more instructions that cause a mobile electronic device to display a navigation guide for directing a user from the starting location to the destination location.

### CROSS-REFERENCE TO RELATED APPLICATIONS

This patent document claims priority to, and is a continuation-in-part of: (1) U.S. patent application Ser. No. 16/809,898, filed Mar. 5, 2020; and (2) U.S. patent application Ser. No. 17/088,786, filed Nov. 4, 2020. The disclosures of all priority documents listed above are fully incorporated into this document by reference.

### BACKGROUND

Mobile electronic device users typically like the ability to navigate indoor environments using their mobile electronic devices so that they can find assets and locations easily. Technologies exist that provide indoor location and navigation. However, these technologies are often cost prohibitive to install and utilize.

For example, indoor location and navigation may be achieved by installing a dedicated infrastructure within an indoor environment. However, the costs associated with the hardware and installation of this infrastructure can be high.

As another example, indoor location and navigation may be performed using an existing infrastructure (e.g., trilateration of WiFi access points). However, these techniques generally have a low accuracy and a high latency.

As yet another example, fingerprinting techniques, such as WiFi fingerprinting, may improve the accuracy and latency of an indoor location and navigation system. However, these techniques involve performing walkthroughs of an environment to generate a reference set of fingerprints that correspond to known positions in an indoor environment. Generating this data is time consuming and can be error-prone in certain environments.

### SUMMARY

This disclosure is not limited to the particular systems, methodologies or protocols described, as these may vary. The terminology used in this description is for the purpose of describing the particular versions or embodiments, and is not intended to limit the scope.

As used in this document, the singular forms “a,” “an,” and “the” include plural references unless the context clearly dictates otherwise. Unless defined otherwise, all technical and scientific terms used in this document have the same meanings as commonly understood by one of ordinary skill in the art. As used in this document, the term “comprising” means “including, but not limited to.”

In an embodiment, a method is provided. The method includes, by a processor of an electronic device, determining a starting location and a destination location, wherein one or both of the locations is located in an environment, receiving a graph representation of a map of the environment, wherein the graph representation of the map includes instances of objects represented as nodes of the graph, and open area paths between objects represented as edges of the graph, determining a plurality of candidate paths from the starting location to the destination location, wherein each of the plurality of candidate paths comprises a set of node-edge combinations that extend from the starting location to the destination location, identifying which of the plurality of candidate paths is a shortest path from the starting point location to the destination object location, selecting the shortest path as a path to navigate from the starting location to the destination location, generating a token comprising one or more instructions for navigating the shortest path, and causing the token to be displayed on a display device of an interactive kiosk, wherein the one or more instructions comprise one or more instructions that cause a mobile electronic device to display a navigation guide for directing a user from the starting location to the destination location when read by the mobile electronic device.

According to various embodiments, the token comprises a Quick Response code.

According to various embodiments, the method further includes receiving a digital image of a floor plan of the environment, extracting text from the digital image, associating an object with each extracted text and a graphic identifier, using the extracted text to assign classes and identifiers to at least some of the associated objects, determining a location in the image of at least some of the associated objects, saving the assigned identifiers and locations in the image of the associated objects to a data set, and generating the graph representation of the map in which instances of objects comprise the associated objects for which the processor determined classes and relative locations appear as instances of objects, and locations in which no objects were detected appear as open areas.

According to various embodiments, the method further includes receiving a digital image file of a floor plan of an indoor location within the environment, parsing the digital image file to identify objects within the floor plan and locations of the identified objects within the floor plan, assigning classes and identifiers to at least some of the identified objects, determining a location in the image of at least some of the identified objects, saving the assigned identifiers and locations of the identified objects to a data set, and generating the graph representation of the map in which the identified objects for which the server determined classes and relative locations appear as instances of objects, and locations in which no objects were detected appear as open areas.

According to various embodiments, the method further includes outputting the shortest path on a display of the electronic device so that the shortest path appears on the map of the environment.

According to various embodiments, determining the destination location includes receiving, from a user of the electronic device, a selection of the destination location via a user interface by one or more of receiving an identifier of the destination location or of a destination object via an input field, receiving a selection of the destination location or of the destination object on the map of the environment as presented on the user interface, or outputting a list of candidate designation locations or destination objects and receiving a selection of the destination object or the destination object from the list.

In an embodiments, a system is provided. The system includes a processor and a memory device. The memory device contains programming instructions that, when executed, cause the processor to determine a starting location and a destination location, wherein one or both of the locations is located in an environment, receive a graph representation of a map of the environment, wherein the graph representation of the map includes instances of objects represented as nodes of the graph, and open area paths between objects represented as edges of the graph, determine a plurality of candidate paths from the starting location to the destination location, wherein each of the plurality of candidate paths comprises a set of node-edge combinations that extend from the starting location to the destination location, identify which of the plurality of candidate paths is a shortest path from the starting point location to the destination object location, select the shortest path as a path to navigate from the starting location to the destination location, generate a token comprising one or more instructions for navigating the shortest path, cause the token to be displayed on a display device of an interactive kiosk, and cause a mobile electronic device to display a navigation guide for directing a user from the starting location to the destination location when read by the mobile electronic device.

According to various embodiments, the token comprises a Quick Response code.

According to various embodiments, the system further includes a memory device with additional programming instructions that are configured to cause a server to receive a digital image of a floor plan of the environment, extract text from the digital image, associate an object with each extracted text and a graphic identifier, use the extracted text to assign classes and identifiers to at least some of the associated objects, determine a location in the image of at least some of the associated objects, save the assigned identifiers and locations in the image of the associated objects to a data set, and generate the graph representation of the map in which instances of objects comprise the associated objects for which the processor determined classes and relative locations appear as instances of objects, and locations in which no objects were detected appear as open areas.

According to various embodiments, the instructions, when executed, further cause the processor to receive a digital image file of a floor plan of an indoor location, parse the digital image file to identify objects within the floor plan and locations of the identified objects within the floor plan, assign classes and identifiers to at least some of the identified objects, determine a location in the image of at least some of the identified objects, save the assigned identifiers and locations of the identified objects to a data set, and generate the graph representation of the map in which the identified objects for which the server determined classes and relative locations appear as instances of objects, and locations in which no objects were detected appear as open areas.

According to various embodiments, the system further includes a display device, and the programming instructions are further configured to cause the processor to output the shortest path on the display device so that the shortest path appears on the map of the environment.

In an embodiment, a method is provided. The method includes, by a mobile electronic device, reading a token that is displayed on a display device of an electronic device to determine an initial position of the mobile electronic device in an indoor environment, wherein the token comprises information pertaining to the initial position of the mobile electronic device, determining an initial heading of the mobile electronic device, determining a relative location associated with the mobile electronic device based on the initial position, initializing a set of particles within a threshold distance from the relative location and within a threshold angle from the initial heading, detecting a move associated with the mobile electronic device, creating a subset of the set of particles based on the move, identifying a path that extends from the relative location away from the mobile electronic device at an angle, determining a first distance between the relative location and a nearest obstacle that is encountered along the path, and filtering the particles in the subset by, for each of the particles in the subset using a map to determine a second distance between a location of the particle and an obstacle nearest to the particle at the angle, determining a difference between the first distance and the second distance, and assigning a probability value to the particle based on the difference. The method further includes, by the mobile electronic device, determining whether a deviation of the probability values does not exceed a threshold probability value, in response to determining that the deviation does not exceed the threshold probability value, estimating an actual location of the mobile electronic device, and causing a visual indication of the actual location to be displayed to a user via a display of the mobile electronic device.

According to various embodiments, the token comprises a Quick Response code.

According to various embodiments, the token includes information pertaining to the initial heading of the mobile electronic device.

According to various embodiments, determining a relative location associated with the mobile electronic device based on the initial position comprises obtaining the relative location from an augmented reality framework of the mobile electronic device.

According to various embodiments, creating a subset of the set of particles based on the move includes, for each of the particles in the set, determining whether the move caused the particle to hit an obstacle as defined by the map, and in response to determining that the move caused the particle to hit an obstacle as defined by the map, not including the particle in the subset.

According to various embodiments, determining the first distance between the relative location and the nearest obstacle that is encountered along the path includes obtaining one or more images of the path that have been captured by a camera of the mobile electronic device, and applying a convolution neural network to one or more of the obtained images to obtain an estimate of the first distance.

According to various embodiments, the convolution neural network has been trained on a loss function, wherein the loss function includes

$${L}_{Primary} = \frac{1}{n} {\sum }_{i = 1}^{n} {e}^{\vert {y}_{i} - {y}_{i ( true )} \vert}$$

L_{primary} is the loss function, n is a matrix of depth perception estimates, Yi is an estimated depth perception estimate at position i in n, and Yₜᵣᵤₑ is an actual distance measurement,

According to various embodiments, using the map to determine the second distance between the location of the particle and the obstacle nearest to the particle at the angle includes determining a map distance between the location of the particle and the obstacle at the angle on the map, and converting the map distance to the second distance using a scaling factor.

According to various embodiments, assigning a probability value to the particle based on the difference comprises assigning the probability value to the particle using a Gaussian function.

### BRIEF DESCRIPTION OF THE DRAWINGS

FIG. 1 illustrates an example indoor location tracking system.

FIG. 2 illustrates an example indoor location tracking method.

FIG. 3 illustrates an example map.

FIG. 4 illustrates an example particle.

FIG. 5 illustrates an example map showing a relative location for a mobile electronic device and locations of example particles.

FIG. 6 illustrates a visual representation of a relative location of a mobile electronic device.

FIG. 7 illustrates an example representation of a convolutional neural network.

FIGS. 8A and 8B illustrate example convolutional neural networks according to various embodiments.

FIG. 9 illustrates example particle distances.

FIG. 10 illustrates an example failed path according to an embodiment.

FIG. 11 illustrates an example method of adjusting a heading of a mobile electronic device.

FIG. 12 illustrates an example floor plan of a building, with locations of multiple items in the building.

FIG. 13 is a flowchart illustrating an example process of ingesting map data into an indoor navigation system.

FIG. 14 illustrates an example beginning of a graph development process in which objects from the floor plan of FIG. 12 are shown as waypoints.

FIGS. 15A and 15B illustrate a next step in a graph development process in which polylines are added to the graph.

FIG. 16 illustrates an example process of using a graph representation of a building floor plan to navigate within the floor plan.

FIGS. 17A-17D illustrate example user interfaces of a navigation application.

FIG. 18 illustrates an example process of using a graph representation and an interactive kiosk to navigate within a floor plan.

FIG. 19 illustrates an example kiosk screen displaying a token and a map of a floor plan.

FIG. 20 illustrates a block diagram of example hardware that may be used to contain or implement program instructions according to an embodiment.

### DETAILED DESCRIPTION

The following terms shall have, for purposes of this application, the respective meanings set forth below:

An “electronic device” or a “computing device” refers to a device that includes a processor and memory. Each device may have its own processor and/or memory, or the processor and/or memory may be shared with other devices as in a virtual machine or container arrangement. The memory may contain or receive programming instructions that, when executed by the processor, cause the electronic device to perform one or more operations according to the programming instructions. Examples of electronic devices include personal computers, servers, mainframes, virtual machines, containers, gaming systems, televisions, and mobile electronic devices such as smartphones, personal digital assistants, cameras, tablet computers, laptop computers, media players and the like. In a client-server arrangement, the client device and the server are each electronic devices, in which the server contains instructions and/or data that the client device accesses via one or more communications links in one or more communications networks. In a virtual machine arrangement, a server may be an electronic device, and each virtual machine or container may also be considered to be an electronic device. In the discussion below, a client device, server device, virtual machine or container may be referred to simply as a “device” for brevity.

The terms “memory,” “memory device,” “computer-readable storage medium”, “data store,” “data storage facility” and the like each refer to a non-transitory device on which computer-readable data, programming instructions or both are stored. Except where specifically stated otherwise, the terms “memory,” “memory device,” “data store,” “data storage facility” and the like are intended to include single device embodiments, embodiments in which multiple memory devices together or collectively store a set of data or instructions, as well as individual sectors within such devices.

The term “obstacle” refers to an object or objects that at least partially block, prevent or hinder an individual from traversing a path in an indoor environment. Examples of obstacles include, without limitation, walls, doors, stairways, elevators, windows, cubicles, and/or the like.

The term “particle” refers to a representation of a particular location and/or a heading in an indoor environment.

The terms “processor” and “processing device” refer to a hardware component of an electronic device that is configured to execute programming instructions. Except where specifically stated otherwise, the singular term “processor” or “processing device” is intended to include both single-processing device embodiments and embodiments in which multiple processing devices together or collectively perform a process.

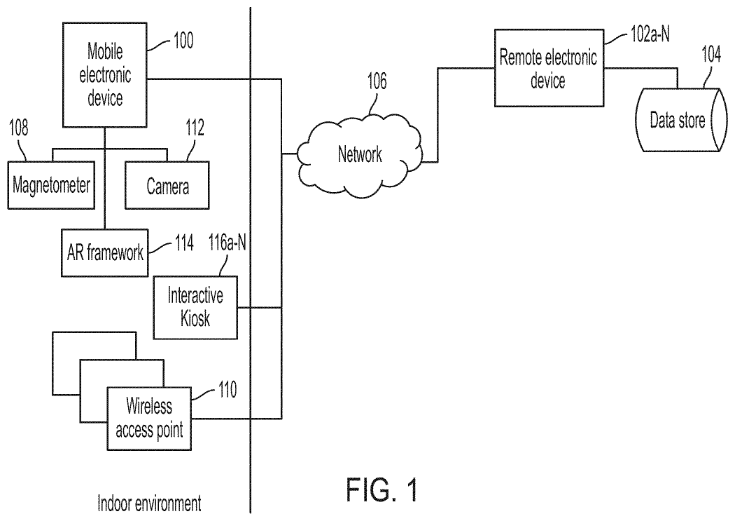

FIG. 1 illustrates an example indoor location tracking system according to an embodiment. As illustrated in FIG. 1, an indoor location tracking system may include a mobile electronic device 100 and one or more remote electronic devices 102a-N. A mobile electronic device 100 may be a portable electronic device such as, for example, a smartphone, a tablet, a laptop, a wearable device and/or the like.

In an embodiment, a remote electronic device 102a-N may be located remotely from a mobile electronic device 100. A server is an example of a remote electronic device 102a-N according to an embodiment. A remote electronic device 102a-N may have or be in communication with one or more data stores 104.

A mobile electronic device 100 may be in communication with one or more remote electronic devices via one or more communication networks 106. A communication network 106 may be a local area network (LAN), a wide area network (WAN), a mobile or cellular communication network, an extranet, an intranet, the Internet and/or the like.

A mobile electronic device 100 may include one or more sensors that provide compass functionality. For instance, a mobile electronic device 100 may include a magnetometer 108. A magnetometer 108 may measure the strength and direction of magnetic fields, which may permit a mobile electronic device 100 to determine its orientation.

A mobile electronic device may include one or more cameras 112. As discussed below, a camera may be an RGB (Red, Green, Blue) camera, an RGB-D camera, and/or the like.

In various embodiments, a mobile electronic device 100 may support an augmented reality (AR) framework 114. An AR framework 114 refers to one or more programming instructions that when executed, cause a mobile electronic device to perform one or more actions related to integrating digital content into a real-world environment. In this document, the term “augmented reality” or “AR” when used with reference to an electronic device or method of using an electronic device, refers to the presentation of content so that the user of the device is able to see at least part of the real-world environment with virtual content overlaid on top of the real-world environment. A mobile electronic device 100 that supports an AR framework 114 may cause virtual content to be overlaid on top of a real-world environment as depicted through a camera application. For example, a camera 112 of a mobile electronic device 100 may capture one or more images of a real-world environment, and an AR framework 114 may cause virtual content to be overlaid on top of these images.

As illustrated in FIG. 1, an indoor location tracking system may include one or more wireless access points 110. A wireless access point 110 refers to a hardware electronic device that permits a wireless enabled electronic device to connect to a wired network. A wireless access point 110 may be a standalone device which is positioned at various locations in an indoor environment. Alternatively, a wireless access point 110 may be a component of another device, such as, for example, a router which is similarly positioned throughout an environment. The wireless access points 110 may be present in a high enough density to service an entire environment.

In various embodiments, a wireless access point 110 may log the time and the strength of one or more communications from a mobile electronic device 100. The wireless access point 110 may send at least part of the logged information to an electronic device such as, for example, a remote electronic device 102a-N. The remote electronic device 102a-N may use the received information to estimate a location of a mobile electronic device 100. For example, a remote electronic device 102a-N may use the received information to determine a position of a mobile electronic device 100 relative to a fixed point in the environment. A remote electronic device may store or have access to a map of a relevant environment, and may use the map to determine a position of a mobile electronic device relative to a reference point. This position may be measured as a certain distance from a reference point, or as one or more position coordinates, such as longitude and latitude.

In various embodiments, an indoor location tracking system may include one or more interactive kiosks 116a-N. An interactive kiosk 116a-N may be an electronic device having a processor, memory, input device, and a display device. An input device may include a keyboard, a mouse, a touchscreen, and/or other suitable devices. An interactive kiosk 116a-N may include one or more cameras or other image capturing devices, one or more microphones, one or more speakers and/or the like. An interactive kiosk 116a-N may be a standalone device. In various embodiments, an interactive kiosk 116a-N may be positioned at certain strategic or high volume areas. For example, a kiosk 116a-N may be positioned in a building lobby or foyer, along a high-traffic hallway or corridor, and/or the like.

In various embodiments, an indoor location tracking system, such as the one described with respect to FIG. 1, may use low accuracy and high latency WiFi location tracking techniques to establish an initial position of a mobile electronic device in an indoor environment. As explained in more detail below, this initial positon may not be a precise or accurate representation of the true location of a mobile electronic device in the indoor environment.

An indoor location tracking system may use information from an AR framework of a mobile electronic device being tracked to establish a relative distance and heading. A depth estimation technology may provide information about distances from the mobile electronic device to one or more obstacles. An indoor location tracking system may utilize a particle filter to fuse together data to provide an indoor location and heading estimate for the mobile electronic device.

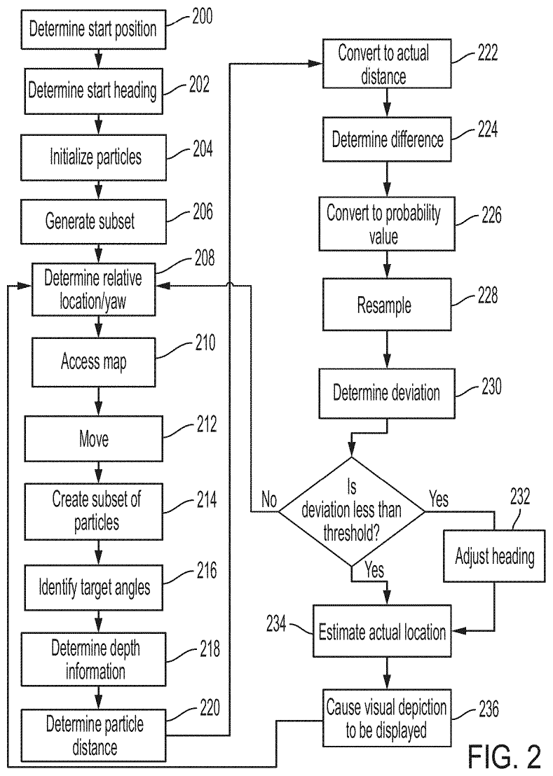

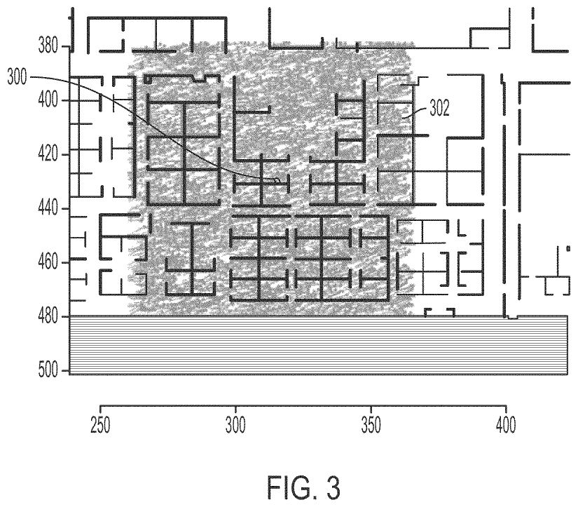

FIG. 2 illustrates an example indoor location tracking method according to an embodiment. As illustrated by FIG. 2, an indoor location tracking system may determine 200 a start position of a mobile electronic device in an indoor environment. An indoor location tracking system may determine 200 a start position of a mobile electronic device by performing WiFi localization according to an embodiment. For instance, a wireless access point located in the indoor environment may log the time and the strength of one or more communications from the mobile electronic device. This information may be used to determine 200 a start position associated with the mobile electronic device. For instance, the wireless access point may send at least part of the logged information to an electronic device such as, for example, a remote electronic device. The remote electronic device may use the received information to estimate a location of a mobile electronic device. In various embodiments, the determined start position associated with a mobile electronic device may be within fifty feet from the true location of the mobile electronic device. FIG. 3 illustrates an example map showing a mobile device's estimated location 300 versus the true location 302 of the mobile electronic device according to an embodiment.

In various embodiments, an indoor location tracking system may determine 202 a start heading associated with the mobile electronic device. For example, one or more sensors of the mobile electronic device (e.g., a magnetometer) may obtain a start heading associated with the mobile electronic device. The obtained start heading may be within twenty degrees of the true heading of the mobile electronic device in various embodiments.

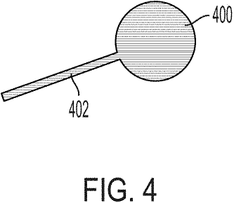

An indoor location tracking system may initialize 204 one or more particles around the start location and start heading for the mobile electronic device. A particle refers to a representation of a particular location and/or a heading in the indoor environment. FIG. 4 illustrates an example particle having a location 400 and heading 402. In an embodiment, an indoor location tracking system may initialize one or more particles by assigning one or more states (e.g., a location and/or a heading) to one or more particles.

An indoor location tracking system may initialize 204 particles within a threshold distance from the start location. For instance, the system may initialize 204 particles +/−50 feet from the start location (e.g., (start x, start y) position). Other threshold distances may be used within the scope of this disclosure. An indoor location tracking system may initialize 204 particles within a threshold angle relative to the start heading. For example, the system may initialize 204 one or more particles within +/−20 degrees from the start heading.

In various embodiments, the system may generate 206 a subset of the initialized particles. The subset may be generated 206 based on a position of the initialized particles. For instance, the system may determine whether any of the initialized particles have a position that corresponds to a position of one or more obstacles as defined by a map of an indoor environment, as discussed in more detail below. The system may generate 206 a subset of particles that excludes these particles.

An indoor location tracking system may determine 208 a relative location and a relative yaw value associated with the mobile electronic device. In various embodiments, an indoor location tracking system may obtain 208 a relative location and/or a relative yaw value from an AR framework associated with the mobile electronic device. A relative location refers to a current location of a mobile electronic device relative to its start location. A relative location of a mobile electronic device may be represented as coordinates such as, for example, (x, y). A relative yaw value refers to a yaw value relative to a start yaw value.

For example, an AR framework may access a camera of a mobile electronic device to obtain one or more images of an indoor environment. The AR framework may perform one or more image processing techniques on the image(s) to determine a relative location and/or a relative yaw value associated with the electronic device. Alternatively, an AR framework may determine a relative location and/or relative yaw associated with an electronic device based on motion information captured by one or more sensors of the mobile electronic device such as, for example, a gyroscope, an accelerometer and/or the like.

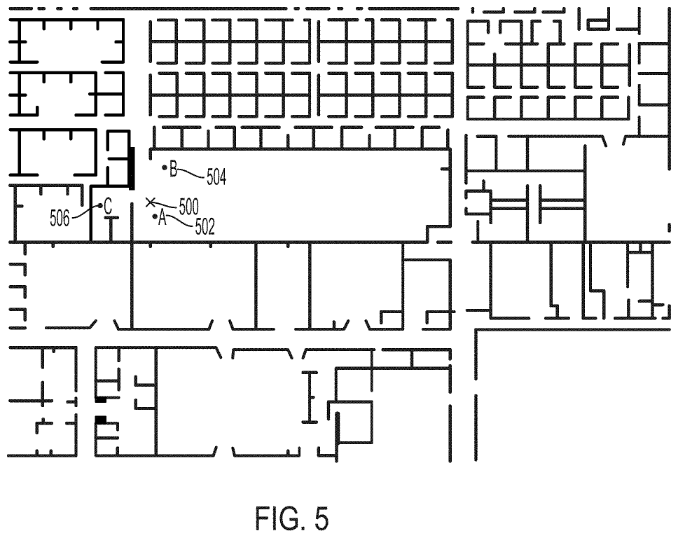

Referring back to FIG. 2, an indoor location tracking system may access 210 a map of the indoor environment. A map may be an electronic representation of the indoor environment. In various embodiments, a map may include visual representations of one or more obstacles in the indoor environment. The obstacles may be permanent or semi-permanent obstacles such as, for example, walls, stairs, elevators, and/or the like. A map may be stored in a data store associated with or accessible to the indoor location tracking system. FIG. 5 illustrates an example map showing a relative location 500 for a mobile electronic device and locations of example particles A 502, B 504, and C 506.

Referring back to FIG. 2, a position of the mobile electronic device may change 212. For example, a user of the mobile electronic device may move or otherwise change position. In various embodiments, the indoor location tracking system may create 214 a subset of particles. The system may determine whether the move has caused one or more of the particles to hit an obstacle as indicated by the map. For example, a mobile electronic device user may move two feet. The system may determine whether adjusting the position of any of the particles by two feet along each particle's heading would cause the particle to hit an obstacle as defined by the map. If the system determines that the move has caused a particle to hit an obstacle, the system may not include the particle in the subset. As such, the subset of particles that is created 214 by the system only includes those particles that the move has not caused to hit an obstacle.

An indoor location tracking system may identify 216 one or more target angles, each referred to in this document as a theta. Each target angle may be within a certain range of the relative yaw value. For example, a theta may be within 20 degrees from the relative yaw value. Additional and/or alternate ranges may be used within the scope of this disclosure.

For each of the identified target angles, the indoor tracking system may determine 218 a distance between a relative location of the mobile device and an obstacle nearest to the relative location at the target angle (referred to in this disclosure as a mobile device distance). In various embodiments, an indoor tracking system may identify a path that extends away from the relative location of the mobile electronic device at the target angle. The system may determine a distance between the relative location and the first (or nearest) obstacle that is encountered along the path.

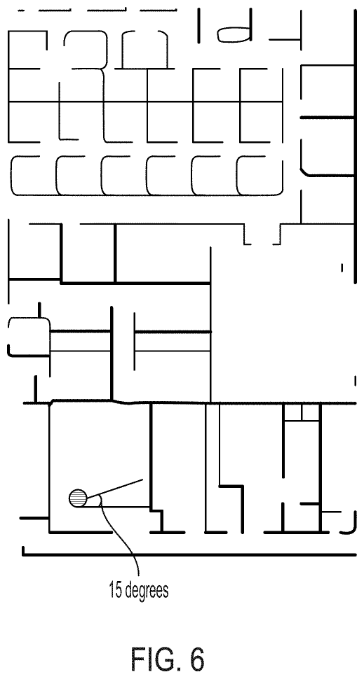

As an example, if a relative location of a mobile electronic device is represented by (A, B) and the target angle is 15 degrees, the indoor tracking system may determine a distance between (A, B) and obstacle at 15 degrees. FIG. 6 illustrates a visual representation of this example according to an embodiment. Table 1 illustrates example theta and distance pairs according to an embodiment.

TABLE 1

| Theta (degrees) | Mobile device distance (feet) |
|---|---|
| 10 | 22 |
| 15 | 16 |
| 20 | 11 |

In various embodiments, the system may determine 218 mobile device distance relative to an obstacle. A camera associated with a mobile electronic device may capture one or more images of its surrounding environment. In various embodiments, the camera may be a monocular RGB (Red, Green, Blue) camera. The camera may be a RGB-D camera, which may include one or more depth-sensing sensors. The depth sensor(s) may work in conjunction with a RGB camera to generate depth information related to the distance to the sensors on a pixel-by-pixel basis. A camera may be integrated into the mobile electronic device such as, for example, a rear-facing and/or a front-facing camera. In other embodiments, a camera may be one that is attached to or otherwise in communication with a mobile electronic device.

The system may obtain one or more of the captured images from the camera, and may apply a machine learning model such as, for example, a convolutional neural network (CNN), to one or more of the obtained images 700 to determine a depth estimate between the mobile electronic device and an obstacle. A CNN may be pre-trained using a set of color images. A CNN may be used to extract image features separate from depth and color modalities, and subsequently combine these features using a fuser technique.

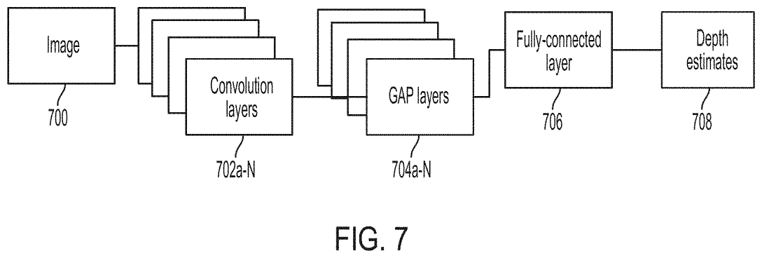

As illustrated by FIG. 7, a CNN may include multiple trainable convolution stages or layers 702a-N connected to one another. Each convolution layer 702a-N may learn hierarchies of features obtained from input data. One or more of the convolution layers 702a-N may extract image features such as, for example, edges, lines, corners and/or the like, from one or more input images 700. An input image may be a color image (e.g., an RGB image) from a dataset of high-resolution color images. A dataset may include at least a portion of images from an image database such as, for example, ImageNet, ResNet50, or another commercially-available or private database having a large number of images. Each image may be converted to a fixed resolution such as, for example, 224×224×3 pixels for RGB images.

For each convolutional layer 702a-N, a set of parameters may be initialized in the form of an array or matrix (referred to in this disclosure as a kernel). The kernel may be applied across a width and height of an input image to convolve the parameters with brightness intensities for the pixels in the input image subject to a threshold for each pixel to generate a feature map having a dimensionality. Each convolution may represent a neuron that looks at only a small region of an input image based on the applied kernel. The number of neurons outputted from a convolution layer may depend on the depth of the applied kernel. A subsequent convolutional layer may take as input the output of a previous convolutional layer and filters it with its own kernel.

In various embodiments, convolutional layers 702a-N may be combined with one or more global average pooling (GAP) layers 704a-N. A GAP layer may calculate the average output of each feature map in the previous layer. As such, a GAP layer 704a-N may serve to significantly reduce the data being analyzed and reduce the spatial dimensions of a feature map.

The output of the GAP layers 704a-N may be provided to a fully-connected layer 706. This output may be represented as a real-valued array having the activations of only a predetermined number of neurons. For instance, the output may be represented as an array of depth estimates 708 for one or more obstacles of an input image.

As an example, applying a CNN to images denoting one or more obstacles may generate a one-dimensional array of depth perception estimates. The array may include one or more angle-distance pairs. An angle value of an angle-distance pair may represent an angle of an obstacle relative to a camera, for example a camera of a mobile electronic device that captured one or more of the images. A distance value of an angle-distance pair may represent an estimated distance between the camera and an obstacle at the corresponding angle. The array may have a length of 224. However, it is understood that alternate lengths may be used within the scope of this disclosure.

In various embodiments, a CNN may be trained on a loss function. An example of such a loss function may be represented by the following:

$${L}_{Primary} = \frac{1}{n} {\sum }_{i = 1}^{n} {e}^{\vert {y}_{i} - {y}_{i ( true )} \vert}$$

where n is a matrix of depth perception estimates having a length of 224;
Yi is an output of the CNN (e.g., a value from n)
Yₜᵣᵤₑ is an actual distance (e.g., one measured by LiDAR or other suitable mechanisms)

This loss function penalizes the bigger errors more than the smaller ones, and helps to stabilize the root mean square error while training. It is understood that other loss functions may be used within the scope of this disclosure.

In various embodiments, a CNN may be fine-tuned based on the following function:

$${L}_{Secondary} = \frac{1}{n} {\sum }_{i = 1}^{n} \vert {y}_{i} - {y}_{i ( true )} \vert$$

where n is a matrix of depth perception estimates having a length of 224;
Yi is an output of the CNN (e.g., a value from n) for measurement i
Yₜᵣᵤₑ is an actual distance (e.g., one measured by LiDAR or other suitable mechanisms) for measurement i

It is understood that other functions may be used to fine tune a CNN.

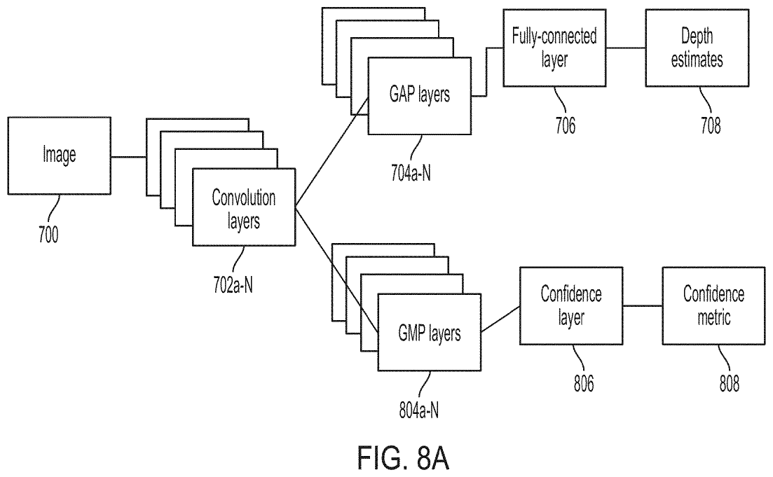

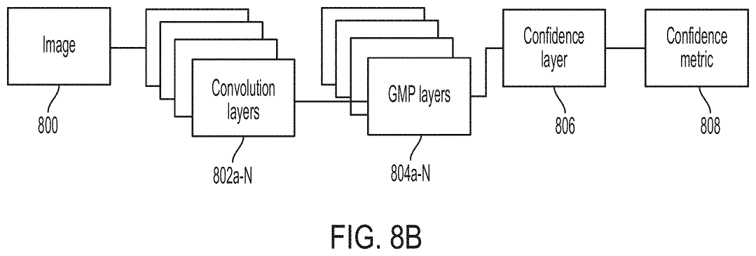

In various embodiments, the system may utilize one or more CNNs to determine a confidence metric associated with one or more of the depth perception estimates described above. In an embodiment, the CNN may be the same CNN as discussed above with respect to FIG. 7, as illustrated in FIG. 8A. Alternatively, the CNN may be a separate CNN than described above, as illustrated in FIG. 8B.

A confidence metric refers to an indication of the accuracy of a depth perception estimate. For instance, a confidence metric may be a value or a range of values that are indicative of a confidence that an associated depth perception estimate is accurate.

FIG. 8B illustrates an example CNN according to an embodiment. As illustrated in FIG. 8, a CNN may include multiple trainable convolution stages or layers 800a-N connected to one another. Each convolution layer 802a-N may learn hierarchies of features obtained from input data. One or more of the convolution layers 802a-N may extract image features such as, for example, edges, lines, corners and/or the like, from one or more input images 700. An input image may be a color image (e.g., an RGB image) from a dataset of high-resolution color images. A dataset may include at least a portion of images from an image database such as, for example, ImageNet, ResNet50, or another commercially-available or private database having a large number of images. Each image may be converted to a fixed resolution such as, for example, 224×224×3 pixels for RGB images.

For each convolutional layer 802a-N, a set of parameters may be initialized in the form of an array or matrix (referred to in this disclosure as a kernel). The kernel may be applied across a width and height of an input image to convolve the parameters with brightness intensities for the pixels in the input image subject to a threshold for each pixel to generate a feature map having a dimensionality. Each convolution may represent a neuron that looks at only a small region of an input image based on the applied kernel. The number of neurons outputted from a convolution layer may depend on the depth of the applied kernel. A subsequent convolutional layer may take as input the output of a previous convolutional layer and filters it with its own kernel.

In various embodiments, convolutional layers 802a-N may be combined with one or more global max pooling (GMP) layers 804a-N. A GMP layer may calculate the maximum or largest output of each feature map in the previous layer.

The output of the GMP layers 804a-N may be provided to a confidence layer 806. This output may be represented as a confidence metric 808. For instance, an example of a confidence metric may be a value between ‘0’ and ‘1’, where values closer to ‘0’ indicate a low confidence and values closer to ‘1’ indicate a high confidence. In various embodiments, applying a CNN may generate a one-dimensional array of confidence values that may correspond to one or more depth perception estimates. As such, a confidence value may indicate an estimated measure of how accurate a depth perception estimate is.

In various embodiments, the system may not update a machine learning model to incorporate a depth perception estimate into if the confidence metric associated with the depth perception estimate is lower than a threshold value, is outside of a range of threshold values, and/or the like. For instance, if confidence metrics have values between ‘0’ and ‘1’, the system may not update a machine learning model to incorporate a depth perception estimate if the confidence metric associated with the depth perception estimate is lower than 0.80. Additional and/or alternate confidence value ranges and/or threshold values may be used within the scope of this disclosure.

For one or more of the particles in the subset, the indoor tracking system may determine 220 a distance between the particle's location and a nearest obstacle at one or more of the identified target angles (referred to in this disclosure as a particle distance).

The indoor tracking system may determine 220 a distance between a particle's location and an obstacle depicted on the map at one or more of the identified target angles. The system may identify a path that extends away from the particle's location at a target angle. The system may determine a distance between the particle's location and the first (or nearest) obstacle that is encountered along the path.

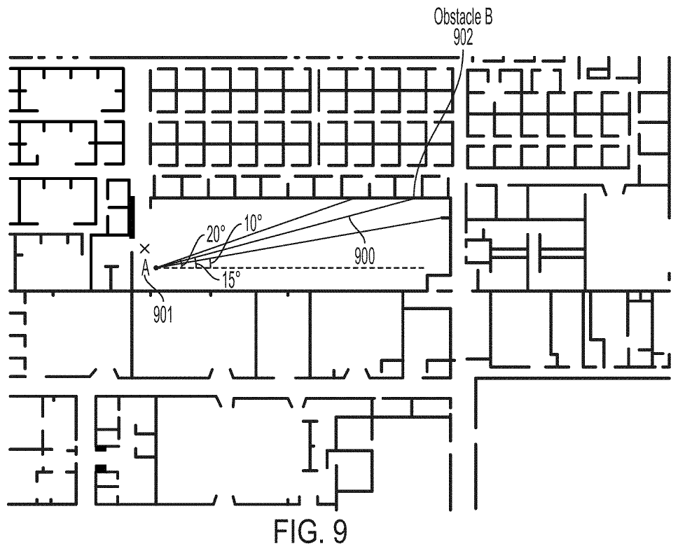

For instance, referring to the example above, the indoor tracking system may determine a distance between each particle's location and a nearest obstacle at one or more of the identified target angles illustrated in Table 1. FIG. 9 illustrates an illustration of example of such distances for Particle A at the various thetas.

Examples of such distances for three example particles are illustrated below in Table 2.

TABLE 2

| | Theta | |
|---|---|---|
| Particle | (degrees) | Particle distance (feet) |
| A | 10 | 25 |
| | 15 | 18 |
| | 20 | 14 |
| B | 10 | 9 |
| | 15 | 6 |
| | 20 | 4 |
| C | 10 | 7 |
| | 15 | 6 |
| | 20 | 21 |

The indoor tracking system may determine 220 a distance between a particle's location and an obstacle depicted on the map at one or more of the identified target angles by measuring a distance between the particle's location and a first obstacle that is encountered at the particular target angle on the map. For example, FIG. 9 illustrates a position of Particle A 901. Line 900 illustrates a distance between Particle A and Obstacle B 902, which is the nearest obstacle encountered when measuring from a theta equal to 15 degrees.

The indoor tracking system may convert 222 the determined distance into an actual distance. The indoor tracking system may convert 222 the determined distance into an actual distance by applying a scaling factor to the determined distance. The scaling factor may be stored in a data store of the indoor tracking system, or a data store associated with the indoor tracking system.

For example, a quarter of an inch on a map may translate to a distance of one foot in the real environment. As such, if a distance between a particle's location and an obstacle is one inch on the map, the actual distance may be determined to be four feet. Additional and/or alternate scaling factors may be used within the scope of this disclosure.

In various embodiments, the indoor tracking system may determine 224 a difference between the mobile device distance at a theta and a particle distance for one or more of the particles at the theta. For instance, referring to the above example, Table 3 illustrates the mobile device distance, particle distance, and difference between the two for each theta.

TABLE 3

| | Theta | Mobile device | Particle distance | Difference |
|---|---|---|---|---|
| Particle | (degrees) | distance (feet) | (feet) | (absolute value) |
| A | 10 | 22 | 25 | 3 |
| | 15 | 16 | 18 | 2 |
| | 20 | 11 | 14 | 3 |
| B | 10 | 22 | 9 | 13 |
| | 15 | 16 | 6 | 10 |
| | 20 | 11 | 4 | 7 |
| C | 10 | 22 | 7 | 15 |
| | 15 | 16 | 6 | 10 |
| | 20 | 11 | 21 | 10 |

The indoor tracking system may convert 226 one or more of the distance values to a probability value. In various embodiments, the indoor tracking system may convert 226 one or more of the distance values to a probability value using any suitable probability distribution such as, for example, a Gaussian function.

The indoor tracking system may resample 228 particles based on their probability values. For instance, the system may select particles having a probability value that is within a certain value range or that exceeds a threshold value. The system may discard the other particles. As such, particles whose distance error is relatively small are more likely to be retained in the resampling.

In various embodiments, the system may determine 230 a deviation associated with the probabilities of the particles in the resampling. A deviation may be a measure of the dispersion of the probabilities relative to one or more certain values. For instance, a deviation may be a standard deviation of the probabilities of the particles in the resampling. Additional and/or alternate deviations may be used within the scope of this disclosure.

If the deviation is not less than a threshold value, the system may repeat steps 208-230 using the resampling. In various embodiments, the system may repeat steps 208-230 until the deviation of the probabilities associated with the particles in the resampling converge. The deviation of the probabilities associated with particles in a resampling may converge when it becomes less than a threshold value.

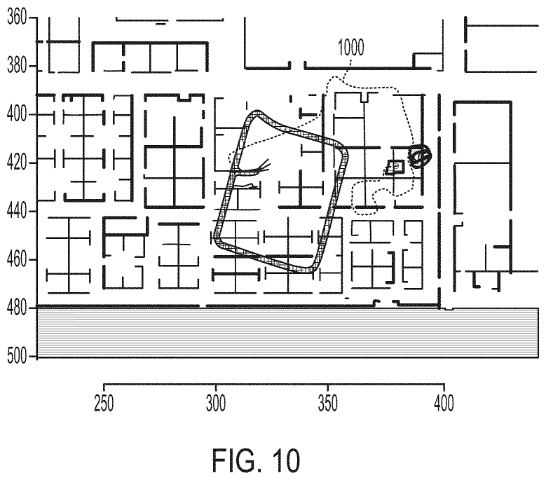

In response to the deviation of the probabilities converging, the system may optionally adjust 232 the heading of the mobile electronic device. If the error associated with the start heading determination is too high, this may result in a failed path associated with the mobile electronic device. A failed path may be a path or trajectory that is not feasible for an individual or a mobile electronic device to follow. For instance, a failed path may be one that passes through one or more obstacles. FIG. 10 illustrates an example of a failed path 1000 according to an embodiment.

To compensate for potentially high error associated with the start heading, the system may adjust 232 the heading. The system may adjust 232 the heading by traversing data sets associated with a failed path in a forward and/or a backward direction for example, by utilizing a forward-backward propagation strategy.

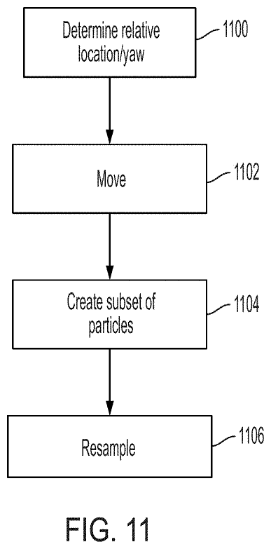

FIG. 11 illustrates an example method of adjusting 232 the heading according to an embodiment. As illustrated in FIG. 11, the system may first traverse the failed path backwards. The system may obtain a current particle set of particles associated with a most recent determined position along the failed path. The system may determine 1100 a relative location and a relative yaw value associated with the mobile electronic device. The system may, for example, determine 1100 a relative location and a relative yaw value in a manner similar to that described above with respect to step 208.

A position of the mobile electronic device may change 1102. For example, a user of the mobile electronic device may move or otherwise change position. In various embodiments, the indoor location tracking system may create 1104 a subset of particles. The system may determine whether the move has caused one or more of the particles in the current particle to hit an obstacle as indicated by the map. If the system determines that the move has caused a particle to hit an obstacle, the system may not include the particle in the subset. As such, the subset of particles that is created 1104 by the system only includes those particles that the move has not caused to hit an obstacle.

The system may then resample 1106 the subset. In various embodiments, the system may randomly sample particles from the subset as part of the resampling. The system may repeat steps 1100-1106 forwards and/or backwards along the failed path in order to adjust the heading of the mobile electronic device.

In various embodiments, the system may estimate 234 an actual location and/or heading of the mobile electronic device based on the resampling. In various embodiments, a system may estimate 234 an actual location and/or heading of the mobile electronic device by determining a metric associated with at least a portion of the particles in the resampling. For example, in an embodiment, the system may estimate 234 an actual location of the mobile electronic device by determining a mean location value or a median location value of the locations of the particles in the resampling. Similarly, the system may estimate 234 an actual heading of a mobile electronic device by determining a mean heading value or a median heading value of the headings of the particles in the resampling.

In various embodiments, the system may adjust an estimated location of the mobile electronic device. The system may adjust an estimated location of the mobile electronic device if the estimated location corresponds to an obstacle on the map. For instance, the system may determine an estimated location, which corresponds to a wall on the map. The system may adjust the estimated location so that the location does not conflict with an obstacle. For instance, the system may determine the nearest location to the estimated location that does not conflict with an obstacle, and may adjust the estimated location to this position.

The system may cause 236 a visual depiction of at least a portion of the map to be displayed on a graphical user interface of the mobile electronic device. The visual depiction may include a visual indication of the estimated actual location on the map. The visual indication may include, for example, a colored dot, a symbol, an image, or other indicator.

As illustrated by FIG. 2, one or more of steps 208-236 may be repeated. For instance, a mobile electronic device user may continue navigating an indoor space, and a visual depiction of his or her location may continue to update on the graphical user interface of the mobile electronic device. This is beneficial in complex spaces, such as large office buildings, where users often have trouble finding places such as conference rooms, the cafe, or bathrooms.

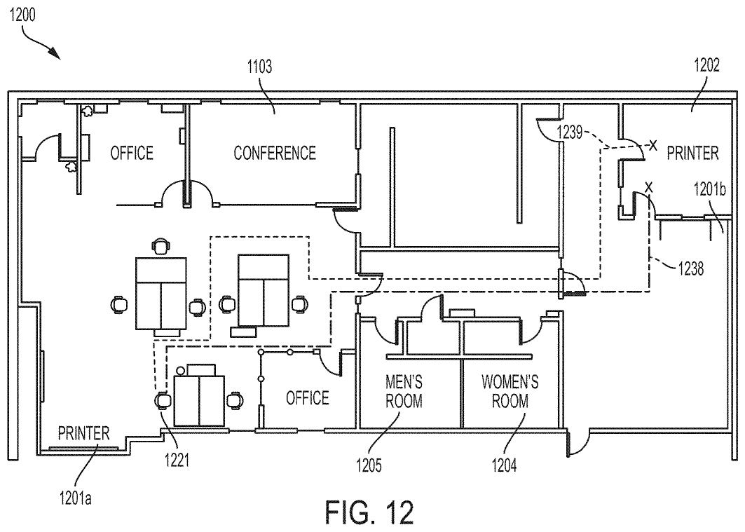

FIG. 12 depicts an example floor map 1200 of a floor of an office building. The building includes various rooms (such as cafeteria 1202, conference room 1203, women's bathroom 1204 and men's bathroom 1205), corridors, doors, items such as print devices 1201a, 1201b and obstacles such as desks and chairs (including chair 1221).

A system may store a digital representation of a floor map 1200 such as that shown. The floor map 1200 may include object labels in the form of text such as room name labels (such as cafeteria 1202, conference room 1203, women's bathroom 1204 and men's bathroom 1205). The floor map 1200 also may object labels that represent certain classes of items located in the building, such as object labels representing print devices 1201a, 1201b and chair 1221.

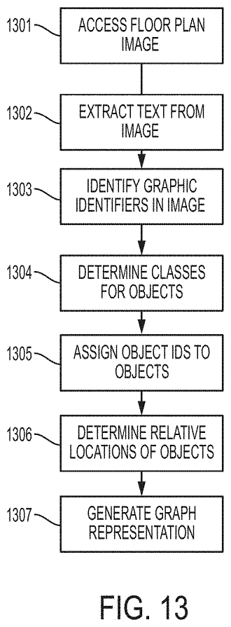

FIG. 13 illustrates a process by which a server (e.g., a remote electronic device 102a-N of FIG. 1), may ingest a floor map, such as floor map 1200 of FIG. 12, to create a data set that the system may use to enable an indoor navigation process. The system may receive the digital floor map as an image file or map file at 1301, and at 1302 the system will analyze the floor map image or map file to extract text-based labels and relative locations of objects in the location that are associated with each label. For example, with reference to FIG. 12, the system may use any suitable text extraction process, such as optical character recognition, to process an image and extract text such as “café” 1202, “conference” 1203, “women's room” 1204, “men's room” 1205, “office” 1207 and 1208, “chair” 1221 and “printer” 1201a and 1201b. Alternatively, if the file is a map file having a searchable structure the system may parse the file for object labels and extract the labels and object locations from the file, without the need for image analysis.

Returning to FIG. 13, at 1304 the system may compare the extracted text with a data set of object classes to determine whether any label matches a known object class, either as an exact match or via a semantically similar match (example: the word “café” is considered semantically similar to “cafeteria”), and, if so, the system will assign the object to that class. At 1305 the system will also assign an object identifier to each object. According to various embodiments, each object identifier may be unique, objects of the same class may share common object identifiers, and/or a hybrid of the two in which some identifiers are unique and some are shared. At 1306 the system will also determine a relative location of the object with respect to a reference point in the image (such as a number of pixels down and to the right of the top leftmost pixel in the image). At 1307 the system may then translate the image map to a graph representation in which each identified object appears as an object instance, and the centerpoint (or another appropriate segment of) of each object label is a waypoint (i.e., a node on the graph), and paths between waypoints are edges of the graph.

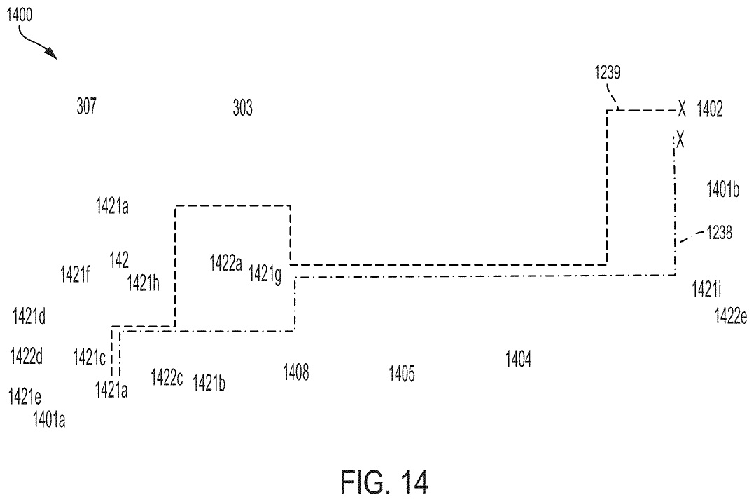

FIG. 14 illustrates an example portion of the graph representation 1400 in which the labels represent instances of objects (example: printers 1401a and 1401b, cafeteria 1402, conference room 1403, women's room 1404, men's room 1405, offices 1407 and 1408, and chairs 1421a), and at least the centerpoint of each label is designated as the object location. (Optionally, one or more pixels adjacent to the centerpoint also may be considered to be part of the waypoint.) The system will then generate polylines between the waypoints using any suitable process, such as skeletonization, manual drawing, or another process.

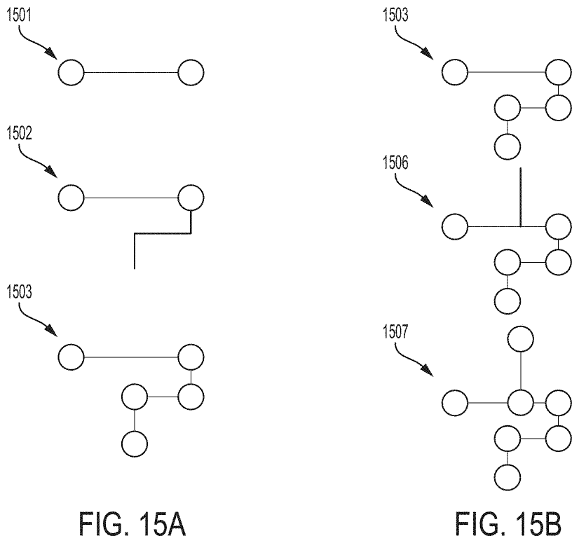

For example, in a skeletonization process, the process will start a polyline at one node, analyze neighboring pixels of the node, and advance the polyline in a direction in which the pixel is not blocked by waypoint or by a building structural element such as a wall. The system will then build the graph representation of paths that may be followed from a starting point to the destination along the polylines. For example, referring to FIGS. 15A and 15B, to build the graph, the system may connect a polyline to the graph when the polyline's vertex matches a note position. This is shown in FIG. 15A, where at 1501 the polyline begins with two nodes and extends beyond the second node at 1502. At 1503 each node on the polyline that is less than one pixel from the node is connected to the graph. In FIG. 15B, the system starts with the graph portion of 1502 and also may identify nodes whose normal (see 1505) is a designated number (e.g., two) or fewer pixels from any edge. At 1507 the system will extend the graph to such nodes.

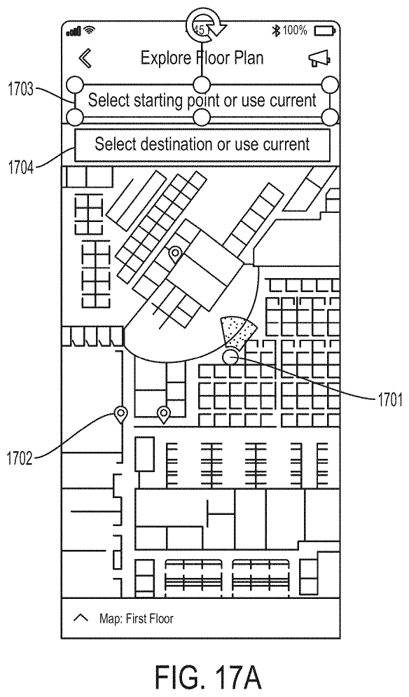

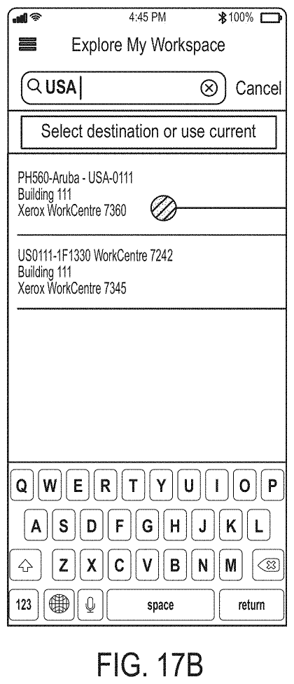

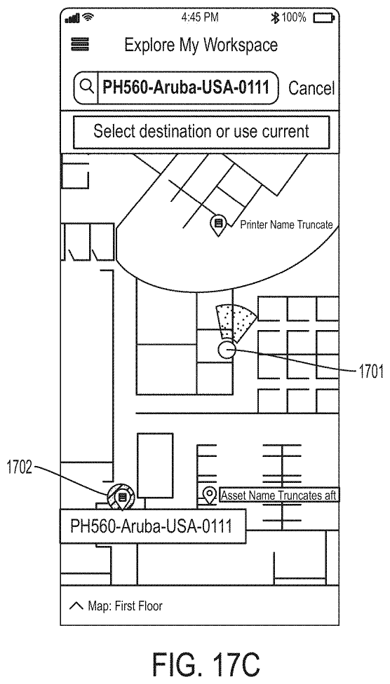

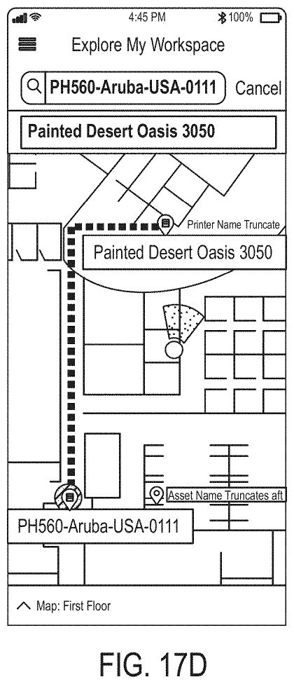

When the graph representation 1400 is complete, as shown in FIG. 17A, at 1601 the system may receive a request to locate and/or navigate to an object. For example, the system may include an application operable on a mobile electronic device that outputs a user interface for an indoor mapping application. The system may select a starting location 1604 of the requester by receiving a location or object ID entered into an input field 1703, by receiving a selection of the location 1701 as output on a displayed map, or by another process, such as by choosing from a list of possible starting points within the map. Some systems may include a speech to text converter in which a user may enter a destination via microphone. A starting point may be detected as a relative position on the map with respect to the reference point that was used to determine the locations of objects on the map. Alternatively, the starting point may be determined as the location of a closest known object. If the location is not already displayed on the displayed map, the location may be displayed after the user enters it.

At 1601 the request to locate and/or navigate to a destination location also may include an identification or location of a destination object 1702. As with the starting location, the destination location 1702 may be received as an identifier of an object that is positioned at the designation location, or as the location itself, entered into an input field 1704, by receiving a selection of the object or destination location 1703 on a displayed map, by outputting a list of objects and/or locations and receiving a selection from the list, by speech-to-text input or by another process. The system may access its data set of object IDs and locations and return a name at 1602 and location at 1603 for the object ID.

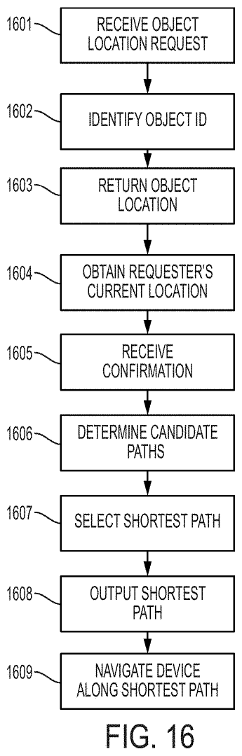

Optionally, as shown in FIGS. 16 and 17B at 1605 the system may output the starting location and the destination location (either as the location, as the object positioned at the location) for the user to confirm, and if multiple candidate destinations are possible the system may output each of them and require the user to select one of the candidate destinations as the confirmed destination. Upon receipt of confirmation the system may output a map rendering (FIG. 17C) that shows the starting point and destination location, optionally after zooming the map in or out as needed to show both locations on the map.

When the system determines the starting location and destination location, at 1606 the system may then compute multiple candidate paths from the starting location to the destination location. The system may do this by any suitable method, for example by following the graph representation in which all the starting and destination locations are represented as nodes, and edges describe all paths between nodes on the graph, which are in open spaces of the building. Open spaces may include areas that do not include objects, or areas that include objects that may be passed through (such as doors). The system may then determine the candidate paths as node-edge combinations that extend from the starting node to the destination node, such as by finding the closest node on the graph to that location, and connecting to that item via the graph. Two candidate paths 1238 and 1239 are shown by way of example in the floor plan 1200 of FIG. 12. At 1607 the system may then determine a shortest path using a method such as Dykstra's algorithm or the Astar algorithm. Then, at 1608 the system may output the shortest path on the displayed map to help the device user navigate to the destination, as shown in FIG. 17D.

In some embodiments, instead of a mobile device application, the steps of FIG. 16 may be performed by an autonomous robotic device. If so, the system may not need to output the user interfaces of FIGS. 17A-17D but instead may simply implement the process of FIG. 16 and then at step 1609 use the determined path as a planned path to navigate the robotic device along the path using any now or hereafter known autonomous device operation process. Robotic navigation processes such as those well known in the art may be used to implement this step.

Also optionally, the process above may be integrated with other electronic device applications to guide a user of the device to a location at which the device causes an operation. For example, a document printing application of an electronic device may output a print job to a selected printer, and then present a user of the device with a path to reach the selected printer. (FIG. 17D illustrates an example of how this may appear to a user of the device.)

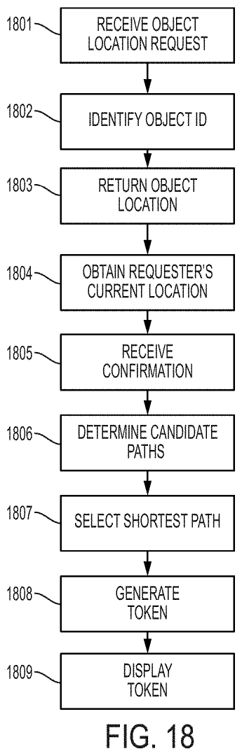

In various embodiments, a kiosk and/or other device for displaying a token for accessing navigation directions to an object or location of interest on a an electronic device (e.g., a mobile electronic device), may be used, as shown in FIG. 18.

As illustrated in FIG. 18, at 1801 the system may receive a request to locate and/or navigate to a destination location. The request may be made via an interactive kiosk, mobile device in electronic communication with the interactive kiosk, and/or other suitable electronic device in electronic communication with an interactive kiosk. For example, a user may input an indication of a destination location using a touch screen of an interactive kiosk. As another example, the system may include an application operable on a mobile electronic device that outputs a user interface for an indoor mapping application.

According to various embodiments, a user may select destination location to which the user requests to navigate. The request to locate and/or navigate to a destination location also may include an identification or location of a destination object. The destination location may be received as an identifier of an object that is positioned at the designation location, or as the location itself, entered into an input field, by receiving a selection of the object or destination location on a displayed map, by outputting a list of objects and/or locations and receiving a selection from the list, by speech-to-text input or by another process. The system may access its data set of object IDs and locations and return a name, at 1802, and location, at 1803, for the object ID. According to some embodiments, the object may be predetermined.

The system may select a starting location 1804 of the requester by determining a location of the interactive kiosk, receiving a location or object ID entered into an input field, by receiving a selection of the location as output on a displayed map, or by another process, such as by choosing from a list of possible starting points within the map. Some systems may include a speech to text converter in which a user may enter a destination via microphone. A starting point may be detected as a relative position on the map with respect to the reference point that was used to determine the locations of objects on the map. Alternatively, the starting point may be determined as the location of a closest known object. If the location is not already displayed on the displayed map, the location may be displayed after the user enters it.

Optionally, at 1805, the system may output the starting location and the destination location (either as the location, as the object positioned at the location) for the user to confirm, and if multiple candidate destinations are possible the system may output each of them and require the user to select one of the candidate destinations as the confirmed destination. The confirmation may be completed using the interactive kiosk, a mobile device, and/or other suitable electronic device. Upon receipt of confirmation, the system may output a map rendering that shows the starting point and destination location, optionally after zooming the map in or out as needed to show both locations on the map.

At 1806, the system may then compute multiple candidate paths from the starting location to the destination location. The system may do this by any suitable method, for example by following the graph representation in which all the starting and destination locations are represented as nodes, and edges describe all paths between nodes on the graph, which are in open spaces of the building. Open spaces may include areas that do not include objects, or areas that include objects that may be passed through (such as doors). The system may then determine the candidate paths as node-edge combinations that extend from the starting node to the destination node, such as by finding the closest node on the graph to that location, and connecting to that item via the graph. At 1807, the system may then determine a shortest path using a method such as, for example, Dykstra's algorithm or the Astar algorithm.

At 1808, the system may generate a token 1902. A token may be a machine-readable code that includes one or more instructions. The one or more instructions may include information as to how to navigate to one or more destination locations. For example, the one or more instructions may indicate where a start location is. The start location may be the location where the token is being displayed. As another example, the one or more instructions may indicate an initial heading that a user should follow to navigate to the destination location. When read by an electronic device, one or more instructions of the token may cause an interactive navigation guide to appear on a display of the electronic device which read the token, aiding a user to navigate to the destination location. A navigation guide refers to an interactive visual aid displayed on a user's mobile electronic device that is configured to display, to the user, the user's position within an environment and a direction in which the user is to travel to reach a destination. The navigation guide may include visual direction, written directions, an avatar representing the user, and/or other suitable features. In various embodiments, a navigation guide may provide a user with turn-by-turn instructions to reach a destination location.

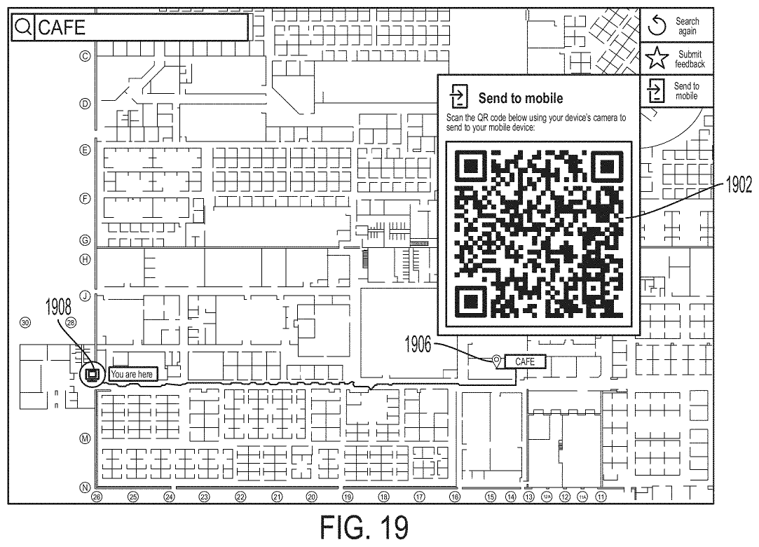

At 1809, the system displays the token to the user such as, for example, on the interactive kiosk. Optionally, as shown in FIG. 19, the system may display the map with the user's starting location 1904 and destination location 1906. As shown in FIG. 19, the token 1902 may be, for example, a Quick Response (QR) code. It is noted, however, that other types of tokens may be used within the scope of the present disclosure. A QR reader of an electronic device may be used to read a QR code that is displayed on display device of an interactive kiosk. For example, a user of a mobile electronic device may use the camera of the mobile electronic device to read a QR code. Additional and/or alternate suitable readers may be used within the scope of this disclosure to read or scan an applicable token.

For example, a token may include a card, a radio frequency identification (RFID) tag, a near field communication (NFC) tag and/or the like. Examples of reader devices include, without limitation, RFID readers, NFC readers, barcode scanners, card readers and/or the like.

In various embodiments, a token may be displayed to a user on a display device of an electronic device, on a physical medium, and/or the like. For example, users arriving to an event at a location may first arrive at a building lobby and may need to be directed to the location of the event within the building. Organizers of the event may cause a token to be displayed in the lobby so that users may read the token with their mobile electronic devices and be directed to the event location with little to no interaction with the organizers. The token may be displayed on a display device of an electronic device such as, for example, a display device of an interactive kiosk, a monitor, a television screen, a tablet, a laptop computer, a desktop computer, a mobile electronic device, a wearable device, and/or the like. As the directions from the building lobby to the event will remain the same, the same token may be displayed to all users. Once read by a mobile electronic device, the token may cause a navigation guide to be displayed on the mobile electronic device, which may provide a user with instructions on how to navigate to the location of the event (i.e., the destination location). The generation of the token and/or the delivery of and implementation of the navigation instructions may be performed as described in this disclosure.

As another example, a token may be printed on a physical medium, such as paper, poster board, plastic, and/or other suitable media. The media may be placed in a location representing the starting location. In the example above, this may be the building lobby. Users who enter the lobby may read the token with their mobile electronic devices. Once read by a mobile electronic device, the token may cause a navigation guide to be displayed on the mobile electronic device, which may provide a user with instructions on how to navigate to the location of the event (i.e., the destination location). The generation of the token and/or the delivery of and implementation of the navigation instructions may be performed as described in this disclosure.

In some embodiments, instead of a mobile device application, the steps of FIG. 16 may be performed by an autonomous robotic device. If so, the system may not need to output the user interfaces of FIGS. 17A-17D but instead may simply implement the process of FIG. 16 and then at step 1609 use the determined path as a planned path to navigate the robotic device along the path using any now or hereafter known autonomous device operation process. Robotic navigation processes such as those well known in the art may be used to implement this step.

Also optionally, the process above may be integrated with other electronic device applications to guide a user of the device to a location at which the device causes an operation. For example, a document printing application of an electronic device may output a print job to a selected printer, and then present a user of the device with a path to reach the selected printer. (FIG. 17D illustrates an example of how this may appear to a user of the device.)

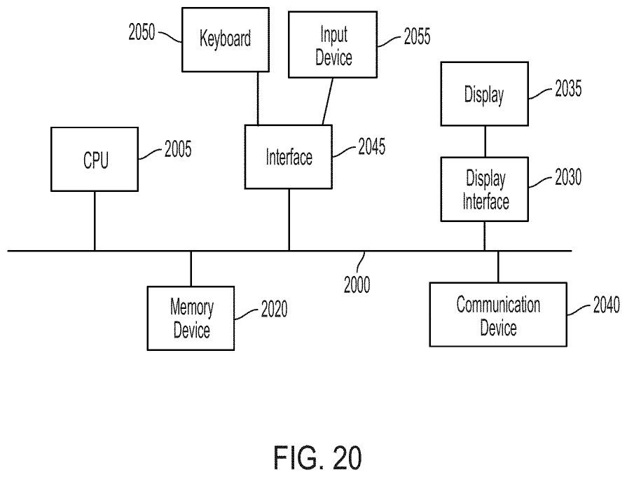

FIG. 20 depicts a block diagram of hardware that may be used to contain or implement program instructions, such as those of a cloud-based server, electronic device, virtual machine, or container. A bus 2000 serves as an information highway interconnecting the other illustrated components of the hardware. The bus may be a physical connection between elements of the system, or a wired or wireless communication system via which various elements of the system share data. Processor 2005 is a processing device that performs calculations and logic operations required to execute a program. Processor 2005, alone or in conjunction with one or more of the other elements disclosed in FIG. 20, is an example of a processing device, computing device or processor as such terms are used within this disclosure. The processing device may be a physical processing device, a virtual device contained within another processing device, or a container included within a processing device.

A memory device 2020 is a hardware element or segment of a hardware element on which programming instructions, data, or both may be stored. Read only memory (ROM) and random access memory (RAM) constitute examples of memory devices, along with cloud storage services.

An optional display interface 2030 may permit information to be displayed on the display 2035 in audio, visual, graphic or alphanumeric format. Communication with external devices, such as a printing device, may occur using various communication devices 2040, such as a communication port or antenna. A communication device 2040 may be communicatively connected to a communication network, such as the Internet or an intranet.

The hardware may also include a user input interface 2045 which allows for receipt of data from input devices such as a keyboard or keypad 2050, or other input device 2055 such as a mouse, a touch pad, a touch screen, a remote control, a pointing device, a video input device and/or a microphone. Data also may be received from an image capturing device 2010 such as a digital camera or video camera. A positional sensor 2015 and/or motion sensor 2065 may be included to detect position and movement of the device. Examples of motion sensors 2065 include gyroscopes or accelerometers. An example of a positional sensor 2015 is a global positioning system (GPS) sensor device that receives positional data from an external GPS network.

The features and functions described above, as well as alternatives, may be combined into many other different systems or applications. Various alternatives, modifications, variations or improvements may be made by those skilled in the art, each of which is also intended to be encompassed by the disclosed embodiments.

What is claimed is:

1. A method, comprising:
by a processor of an electronic device:
determining a starting location and a destination location, wherein one or both of the locations is located in an environment,
receiving a graph representation of a map of the environment, wherein the graph representation of the map includes instances of objects represented as nodes of the graph, and open area paths between objects represented as edges of the graph,
determining a plurality of candidate paths from the starting location to the destination location, wherein each of the plurality of candidate paths comprises a set of node-edge combinations that extend from the starting location to the destination location,
identifying which of the plurality of candidate paths is a shortest path from the starting point location to the destination object location,
selecting the shortest path as a path to navigate from the starting location to the destination location,
generating a token comprising one or more instructions for navigating the shortest path, and
causing the token to be displayed on a display device of an interactive kiosk, wherein the one or more instructions comprise one or more instructions that cause a mobile electronic device to display a navigation guide for directing a user from the starting location to the destination location when read by the mobile electronic device.

2. The method of claim 1, wherein the token comprises a Quick Response code.

3. The method of claim 1, further comprising:
receiving a digital image of a floor plan of the environment;
extracting text from the digital image;
associating an object with each extracted text and a graphic identifier;
using the extracted text to assign classes and identifiers to at least some of the associated objects;
determining a location in the image of at least some of the associated objects;
saving the assigned identifiers and locations in the image of the associated objects to a data set; and
generating the graph representation of the map in which:
instances of objects comprise the associated objects for which the processor determined classes and relative locations appear as instances of objects, and
locations in which no objects were detected appear as open areas.

4. The method of claim 1, further comprising:
receiving a digital image file of a floor plan of an indoor location within the environment;
parsing the digital image file to identify objects within the floor plan and locations of the identified objects within the floor plan;
assigning classes and identifiers to at least some of the identified objects;
determining a location in the image of at least some of the identified objects;
saving the assigned identifiers and locations of the identified objects to a data set; and
generating the graph representation of the map in which:
the identified objects for which the server determined classes and relative locations appear as instances of objects, and
locations in which no objects were detected appear as open areas.

5. The method of claim 1, further comprising outputting the shortest path on a display of the electronic device so that the shortest path appears on the map of the environment.

6. The method of claim 1, wherein determining the destination location comprises:
receiving, from a user of the electronic device, a selection of the destination location via a user interface by one or more of the following:
receiving an identifier of the destination location or of a destination object via an input field;
receiving a selection of the destination location or of the destination object on the map of the environment as presented on the user interface; or
outputting a list of candidate designation locations or destination objects and receiving a selection of the destination object or the destination object from the list.

7. A system, comprising:
a processor; and
a memory device containing programming instructions that, when executed, cause the processor to:
determine a starting location and a destination location, wherein one or both of the locations is located in an environment,
receive a graph representation of a map of the environment, wherein the graph representation of the map includes instances of objects represented as nodes of the graph, and open area paths between objects represented as edges of the graph,
determine a plurality of candidate paths from the starting location to the destination location, wherein each of the plurality of candidate paths comprises a set of node-edge combinations that extend from the starting location to the destination location,
identify which of the plurality of candidate paths is a shortest path from the starting point location to the destination object location,
select the shortest path as a path to navigate from the starting location to the destination location,
generate a token comprising one or more instructions for navigating the shortest path,
cause the token to be displayed on a display device of an interactive kiosk, and
cause a mobile electronic device to display a navigation guide for directing a user from the starting location to the destination location when read by the mobile electronic device.

8. The system of claim 7, wherein the token comprises a Quick Response code.

9. The system of claim 7, further comprising a memory device with additional programming instructions that are configured to cause a server to:
receive a digital image of a floor plan of the environment;
extract text from the digital image;
associate an object with each extracted text and a graphic identifier;
use the extracted text to assign classes and identifiers to at least some of the associated objects;
determine a location in the image of at least some of the associated objects;
save the assigned identifiers and locations in the image of the associated objects to a data set; and
generate the graph representation of the map in which:
instances of objects comprise the associated objects for which the processor determined classes and relative locations appear as instances of objects, and
locations in which no objects were detected appear as open areas.

10. The system of claim 7, wherein the instructions, when executed, further cause the processor to:
receive a digital image file of a floor plan of an indoor location;
parse the digital image file to identify objects within the floor plan and locations of the identified objects within the floor plan;
assign classes and identifiers to at least some of the identified objects;
determine a location in the image of at least some of the identified objects;
save the assigned identifiers and locations of the identified objects to a data set; and
generate the graph representation of the map in which:
the identified objects for which the server determined classes and relative locations appear as instances of objects, and
locations in which no objects were detected appear as open areas.

11. The system of claim 7, further comprising:
a display device; and
wherein the programming instructions are further configured to cause the processor to output the shortest path on the display device so that the shortest path appears on the map of the environment.

12. A method, comprising:
by a mobile electronic device:
reading a token that is displayed on a display device of an electronic device to determine an initial position of the mobile electronic device in an indoor environment, wherein the token comprises information pertaining to the initial position of the mobile electronic device,
determining an initial heading of the mobile electronic device,
determining a relative location associated with the mobile electronic device based on the initial position,
initializing a set of particles within a threshold distance from the relative location and within a threshold angle from the initial heading,
detecting a move associated with the mobile electronic device,
creating a subset of the set of particles based on the move,
identifying a path that extends from the relative location away from the mobile electronic device at an angle,
determining a first distance between the relative location and a nearest obstacle that is encountered along the path,
filtering the particles in the subset by, for each of the particles in the subset:
using a map to determine a second distance between a location of the particle and an obstacle nearest to the particle at the angle,
determining a difference between the first distance and the second distance, and
assigning a probability value to the particle based on the difference,
determining whether a deviation of the probability values does not exceed a threshold probability value,
in response to determining that the deviation does not exceed the threshold probability value, estimating an actual location of the mobile electronic device, and
causing a visual indication of the actual location to be displayed to a user via a display of the mobile electronic device.

13. The method of claim 12, wherein the token comprises a Quick Response code.

14. The method of claim 12, wherein the token includes information pertaining to the initial heading of the mobile electronic device.

15. The method of claim 12, wherein determining a relative location associated with the mobile electronic device based on the initial position comprises obtaining the relative location from an augmented reality framework of the mobile electronic device.

16. The method of claim 12, wherein creating a subset of the set of particles based on the move comprises:
for each of the particles in the set:
determining whether the move caused the particle to hit an obstacle as defined by the map, and
in response to determining that the move caused the particle to hit an obstacle as defined by the map, not including the particle in the subset.

17. The method of claim 12, wherein determining the first distance between the relative location and the nearest obstacle that is encountered along the path comprises:
obtaining one or more images of the path that have been captured by a camera of the mobile electronic device; and
applying a convolution neural network to one or more of the obtained images to obtain an estimate of the first distance.

18. The method of claim 17, wherein the convolution neural network has been trained on a loss function, wherein the loss function comprises
$${L}_{Primary} = \frac{1}{n} {\sum }_{i = 1}^{n} {e}^{\vert {y}_{i} - {y}_{i ( true )} \vert}$$
wherein:
L_{primary} is the loss function,
n is a matrix of depth perception estimates,
Yi is an estimated depth perception estimate at position i in n,
Yₜᵣᵤₑ is an actual distance measurement,

19. The method of claim 12, wherein using the map to determine the second distance between the location of the particle and the obstacle nearest to the particle at the angle comprises:
determining a map distance between the location of the particle and the obstacle at the angle on the map; and
converting the map distance to the second distance using a scaling factor.

20. The method of claim 12, wherein assigning a probability value to the particle based on the difference comprises assigning the probability value to the particle using a Gaussian function.
